(19) United States
(12) Patent Application Publication
(10) Pub. No.: US 2007/0015560 A1
(43) Pub. Date: Jan. 18, 2007

(54) GAME OF BASEBALL WITH MODIFIED BASE-ON-BALLS RULE

(76) Inventor: Richard S. Lister, Costa Mesa, CA (US)

Correspondence Address: TECHNOLOGY LAW GROUP, LLC, 8950 W. EMERALD STREET STE. 198, BOISE, ID, 83704, US

(21) Appl. No.: 11/457,660

(22) Filed: Jul. 14, 2006

Related U.S. Application Data
(60) Provisional application No. 60/699,807, filed on Jul. 15, 2005.

(51) Int. Cl. A63F 13/00

(52) U.S. Cl. 463/3

(57) ABSTRACT

An organized game of baseball is carried out under traditional rules of play modified such that a player at bat who is given a base-on-balls can choose to either take the base or remain at bat for additional pitches while a replacement runner takes the base. Replacement runners can be selected in a predetermined line-up order or in random order from the bench or from the active roster. Optionally, certain restrictions may be provided to control or limit how often replacement runners can be used by a team in a given inning and/or game.

### RELATED APPLICATION

This application claims priority under 35 U.S.C. 119(e) to U.S. Provisional Patent Application Ser. No. 60/699,807 filed Jul. 15, 2005 and entitled GAME OF BASEBALL WITH MODIFIED BASE-ON-BALLS RULE, the disclosure of which is incorporated herein in its entirety.

### BACKGROUND

1. Field of the Invention

The present invention relates to the game of baseball and, in particular, to a set of improved rules and methods of play for enhancing the enjoyment and excitement thereof.

2. Description of the Related Art

Baseball, an American invention for more than a century, is so ingrained in the American culture that it is commonly referred to as the “national pastime.” Jacques Barzun, a Ph.D., U.S. historian, and educator from Columbia University, wrote in God's Country and Mine (1954), “whoever wants to know the heart and mind of America had better learn baseball, the rules and realities of the game. . . .”

But, there is a serious, fundamental flaw in the rules of baseball. In fact, baseball retains the single worst rule in all of sports-a rule so egregious and ill-advised that it would almost certainly not be tolerated in any other sport, profession, or occupation. This rule is the “base-on-balls” (a.k.a. “the walk”). No other major sport has a comparable regulation, which so destroys the enjoyment and interest of a competitive sport.

Millions of fans pay billions of dollars yearly to watch major league baseball games. If a team is fortunate enough to have a great hitter, a slugger of home runs, fans are all too often deprived of seeing this superstar perform because of the base-on-balls rule. Consider, for example, one of the all-time greatest hitters, Ted Williams. In 19 seasons Williams played in 2292 games, averaging 406 at bats per season, hitting a total of 521 homers, and earning a lifetime batting average of 0.344. Baseball experts often lament that Williams would have challenged Babe Ruth's career home run record of 714 had he not served 5 years as a fighter pilot in World War II and Korea. But, what these experts fail to consider is that Williams lost an additional 5 years of at bats, by receiving 2,019 bases on balls. Baseball fans also lost out. Rather than witnessing a tremendous hitter being given the opportunity to compete against the greatest pitchers of his time, fans witnessed a walk; they were denied this opportunity because of the base-on-balls rule. As Giants President, Peter Magowan, once observed “[It's not] very good marketing for the game of baseball. It takes the contest (between pitcher and batter) away in the most boring way possible.”

The base-on-balls rule seriously diminishes the competitive and entertainment value of baseball by effectively denying the best players in the game the opportunity to play. During the most dramatic moments of a game, the best and most powerful hitters are denied participation by the base-on-balls rule. The fans are left with lesser skilled players deciding the outcome of the competition. Rather than being allowed to watch the greatest hitters perform in crucial situations, the opposing team chooses to simply avoid the confrontation by walking the batter and accepting the small penalty of allowing him a “free pass” to first base.

Not surprisingly, the most walked players in baseball's history are also its greatest all-time hitters. Babe Ruth had a career total of 2,056 bases on balls. This is the equivalent of five full seasons of not being allowed to bat. Ruth led the league in bases on balls for 10 seasons, with a highest single season total of 170. This is the equivalent of totally denying him the opportunity to bat in 42.5 of the 152 games Ruth played in 1923.

In 2002, San Francisco outfielder Barry Bonds eclipsed Ruth's single-season walk total with consecutive seasons of 177 and 198 bases-on-balls in 2001 and 2002, respectively. Bonds' 2002 base-on-balls total was 1,922 and he has since gained more than the additional 135 base-on-balls needed to pass Ruth. Such prodigious walk totals represent not only a tremendous waste of sports talent, they also represent a tremendous waste of entertainment value to the millions of fans who would otherwise delight in seeing their favorite slugger hit one over the fence.

This waste of talent and entertainment value ultimately translates into an immense loss of revenue for baseball team owners and league operators. Baseball is not the only sport to have captured the hearts (and dollars) of American sports fans. Today, there are many exciting sports and sports leagues to choose from and there is fierce competition for sports entertainment dollars. In fact, there are many critics who believe that baseball has become so antiquated and unexciting relative to newer sports that it can no longer be called the national pastime. Many consider the game too slow with not enough play action to keep fans attention. The current base-on-balls rule contributes to this slow, unexciting play, thereby putting baseball at a competitive disadvantage relative to other popular sports, such as football, basketball, and hockey.

### SUMMARY

Accordingly, it is a principle object and advantage of the present invention to improve and modify the rules of play of the game of baseball in a way that helps improve the overall excitement and entertainment value of the game by helping ensure that the best and most talented offensive athletes will have equal opportunity to compete.

In accordance with one embodiment the present invention provides a game of baseball modified such that a player at bat who is given a base-on-balls can choose to either take the base or remain at bat for additional pitches while a replacement runner takes the base. Replacement runners can be selected in a predetermined line-up order or in random order from the bench or from the active roster. Optionally, certain restrictions may be provided to control or limit how often replacement runners can be used by a team in a given inning and/or game.

In accordance with another embodiment the invention provides a method for carrying out a game of baseball. The game is carried out in accordance with traditional or conventional rules, modified in that the traditional base-on-balls rule gives the player at bat the choice to either take the base or remain at bat for additional pitches while a replacement runner takes the base. Replacement runners can be selected in a predetermined line-up order or in random order from the bench or from the active roster. Optionally, certain restrictions may be provided to control or limit how often replacement runners can be used by a team in a given inning and/or game.

For purposes of summarizing the invention and the advantages achieved over the prior art, certain objects and advantages of the invention have been described herein above. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

FIG. 1 is an overhead view illustrating a playing field and game situation as described in the claims and in Example 1 below;

FIG. 2 is an overhead view illustrating a playing field and game situation as described in the claims and in Example 1 below;

FIG. 3 is an overhead view illustrating a playing field and game situation as described in the claims and in Example 1 below; and

FIG. 4 is an overhead view illustrating a playing field and game situation as described in the claims and in Example 2 below.

### DETAILED DESCRIPTION

A baseball-type game is played on a playing field including first, second, and third bases, home plate, an infield, and an outfield. The game is generally carried out in accordance with traditional rules of baseball game play including rules defining strikes, balls, runs and outs, except that the rules of game play are modified such that a player at bat who is pitched a predetermined number of balls without first reaching a predetermined number of strikes can choose to either: (i) advance to first base; or (ii) stay at home plate and receive additional pitches while a replacement runner advances to first base.

In accordance with one preferred embodiment of the invention the base-on-balls rule of traditional baseball play (e.g., baseball carried out according to rules of play published by the American Baseball League (AL), National Baseball League (NL), Major League Baseball (MLB), National Collegiate Athletic Association (NCAA), National Federation of State High School Associations (NFHS), Youth Baseball League, etc., which published rules are included herein by reference) is modified so that once a player-at-bat receives a full count of “balls” (i.e, 4 balls) that player would have the option of: (i) either walking to first base himself (i.e., as with the conventional base-on-balls rule); or (ii) selecting another player from the team to serve as a replacement runner (“RR”). This allows the batter, if he elects, to remain at the plate and receive additional pitches with a replacement runner on first base.

Preferably, under the proposed modified rule (although not necessarily), individual players may only be used as replacement runners once per inning (or at least until the entire roster of eligible players is exhausted). This discourages teams from stacking their roster with non-baseball ability track sprinters and the like for the sole purpose of running for base-on-balls recipients. These RRs could be selected in a set order (e.g., batting order) or out of order or randomly, as desired. Of course, should the manager choose the traditional option of allowing the hitter to take first base, the standard pinch runner policy may also be used with the replaced player being put out of the game. However, unlike a pinch runner, a replacement runner would preferably still be eligible to play later in the game as a substitute as with conventional rules (e.g., defensive purposes, pinch hitter, etc.).

If a batter elects not to take a base-on-balls and a RR is used, the batter may be given a fixed number of additional pitches, an additional number of balls or strikes, or a new at-bat may be commenced as though a new batter were coming to the plate. If the same player is walked in consecutive at bats, the batter may take first base or additional RR's used until a fixed number of at-bats is reached or until the batter gets a hit, makes an out, or accepts a base-on-balls. In a preferred embodiment, the ball/strike count is reset to zero balls and zero strikes and the play continues as if a new batter were at the plate. In another embodiment, the ball count is reset to zero balls and the strike count is not modified. Such a rule may have the added benefit of encouraging aggressive pitching by the pitcher after a RR is used. It may also discourage the use of a RR where the pitcher has managed to get one or two strikes, but gives up a walk to a selective batter or an umpire that calls a small strike zone. In yet another embodiment, the count is unchanged and the hitter must be pitched to until he gets a hit or makes an out or is given an additional number of pitches before another base-on-balls is awarded. Different rules regarding the subsequent pitches or at-bats after a RR is used will, of course, affect game play and game strategies in different ways. Such rules may encourage or discourage the use of a RR in a given situation adding new layers of strategy to the game.

The RR may be selected by the manager from the active or inactive roster or may be selected from a predetermined list or order, which may or may not be based on the batting order or lineup at that point in the game. For purpose of this description, the term roster signifies all players eligible to play in the game prior to the beginning of the game. The term active roster refers to those players in the current lineup or then active in the game. Inactive roster refers to those players eligible to enter the game as subtitutes for members of the active roster.

A primary goal and advantage of the modified rule is to discourage pitchers from intentionally walking the opposing team's best hitters and to make it more probable that the best hitters will be given a fair opportunity to swing the bat. Advantageously, the proposed modified rule forces pitchers to challenge good hitters with good pitches. With the modified rule in effect, a pitcher would seldom if ever gain an advantage by walking a good batter. This is because under the modified rule the good batter can elect to stay at the plate and receive additional pitches while a replacement runner takes the walk to first base. This helps ensure that the best hitters on each team will receive an equal number of opportunities to hit the ball. This is a significant improvement over the traditional system of selective avoidance.

The modified base-on-balls rule also ensures that pitchers will have an opportunity of giving their best performance on each pitch thrown. This will not only increase the excitement of the game, but also reduce overall playing time. In fact, statisticians have estimated that a 2 ½ hour baseball game has only 10 minutes of play action. By minimizing the number of times pitchers intentionally walk batters (a non-play-action event) the proposed modified rule increases game play action while at the same time reducing game play duration.

The proposed modified rule also increases game strategy opportunities, making for an overall more intriguing and exciting game. For example, sometimes a manager might elect to have a walked weak hitter remain at the plate. Perhaps the player bunts well and can sacrifice the RR to second base. Sometimes, a pitcher may even want a runner on first base with a strong batter at the plate in order to possibly force a double play. For example, the batter may be prone to hitting in-field pop-flies and/or ground ball double play outs.

Another primary concern at the major league level is that as pitchers have become more and more specialized, it is often frightening and risky having them perform other baseball skills. Pitchers running, sliding, and crashing into catchers blocking home plate are risking career ending injuries. In the National League pitchers are required to bat. Under the modified rules, should they receive a base on balls, the offensive manager could elect to have them take first base, unless the next-up RR happens to be a great base runner and the pitcher an excellent bunter. Such a combination would help the manager to keep the pitcher off the bases, while bunting the RR to second. This allows additional strategy, but not at the price of eliminating quality athletic hitting.

### EXAMPLE 1

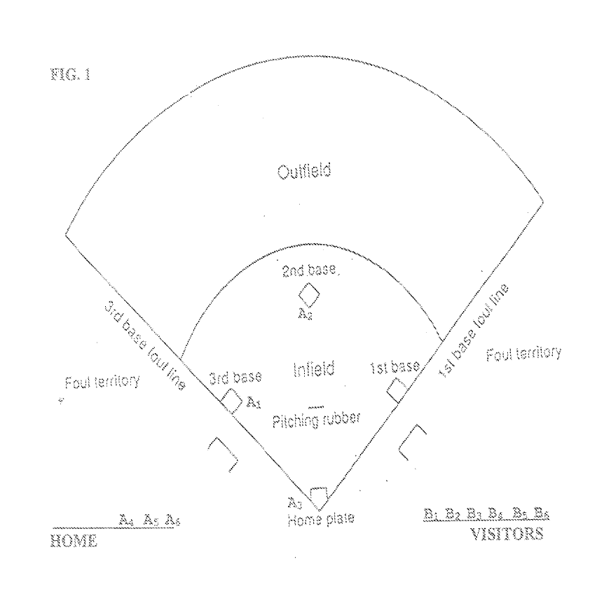

As illustrated in FIG. 1, suppose in a particular inning team “A” opens with a single followed by a double leaving runners A₁, A₂ on second and third with no outs. The team “B” pitcher (either intentionally or unintentionally) issues a base-on-balls to the next hitter, player A₃.

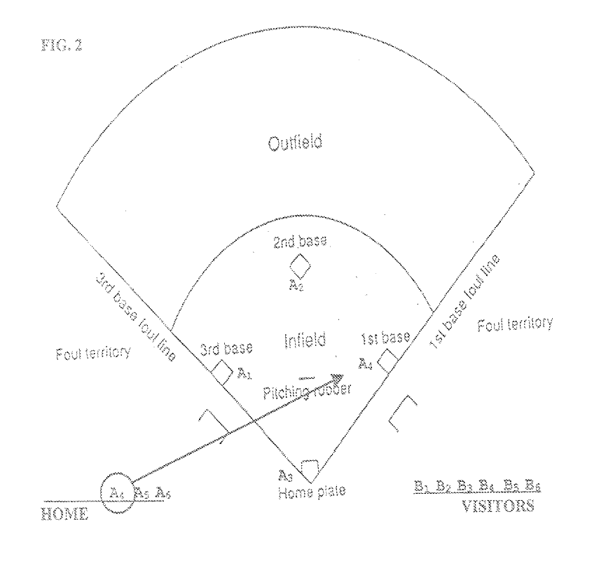

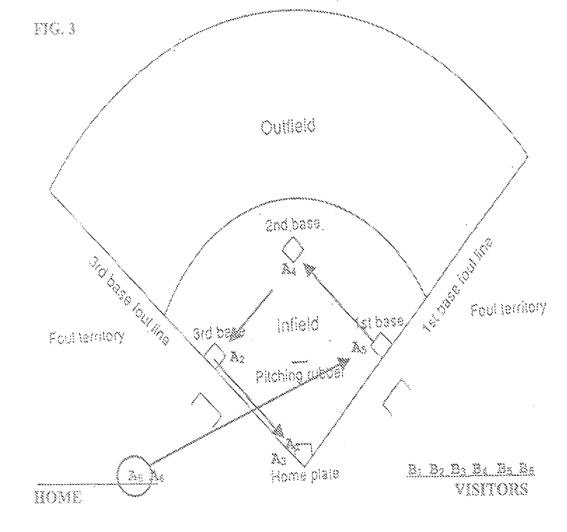

Under the proposed modified rules, player A₃ (or the hitting team's manager) has the option to allow the walked hitter to take first base, or to select a bench player (or, alternatively, a player from the active roster) to act as the replacement runner (RR), keeping the same hitter at bat. In this case, team “A” elects player A₄ to be the replacement runner, and he takes the base as illustrated in FIG. 2.

Preferably, the RR is allowed to serve as a replacement runner only once per inning or, more preferably, only once per game. For example, his name may be circled on the lineup card indicating that the player may still play later in some other capacity (pinch hitter, defensive purposes, relief pitcher, etc.), but not as a base runner for another player during that inning or, more preferably, the remainder of the game. However, if all bench players have served as replacement runners in a given inning or game, as the case may be, then preferably, such players are allowed to again serve as replacement runners. Those skilled in the art will appreciate that replacement runners may be selected in a particular predetermined line-up order or not, as desired.

Continuing with the play action of Example 1, it is possible (though not likely) that this same hitter (player A₃) could be walked a second consecutive time giving his manager the same option of choosing a second replacement runner as shown in FIG. 3. In this case, a second replacement runner A₅ is selected and advanced to first base as player A₁ advances to home plate for a scored run.

### EXAMPLE 2

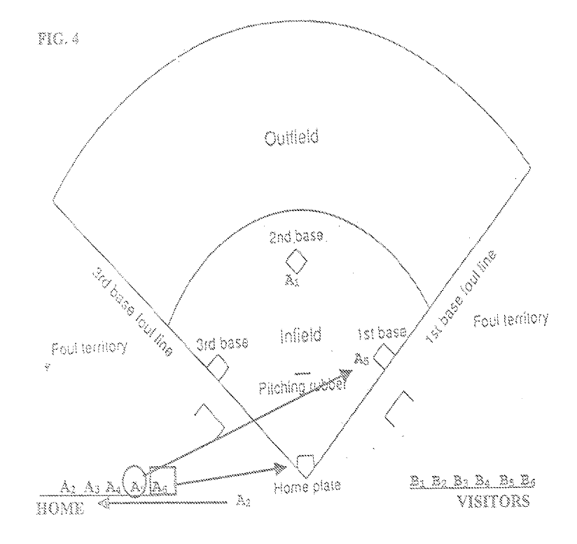

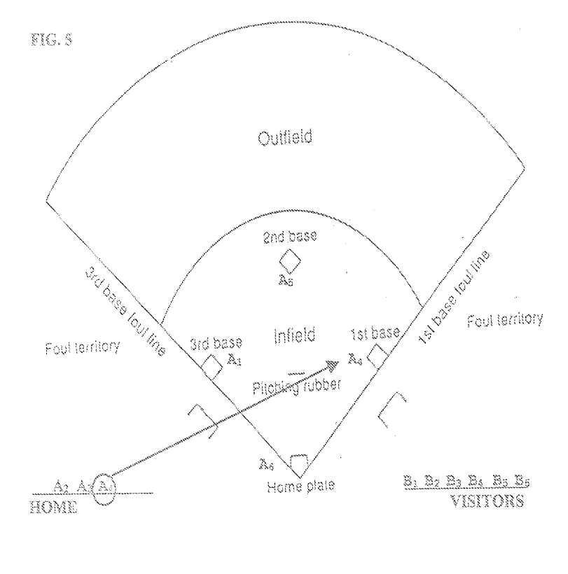

As illustrated in FIG. 4 suppose the game boils down to a tight pitchers duel in the last of the 9.sup.th inning with the score tied 1-1. There are no outs with a runner A₁ on second base representing the potential winning run. At the plate is a power hitter A₂ who is also a slow runner. The pitcher or defensive manager strategically elects to give the hitter an intentional base on balls to set up a possible double play. Under the proposed modified base-on-balls rule, the hitter A₂ can choose to either take the base or stay at bat with a replacement runner taking the walk.

To counter this defensive maneuver, the offensive manager elects to make several tactical decisions. First, he chooses to give his slow running power-hitter A₂ a replacement runner A₅ at first base. Then he brings in a pinch hitter A₆ who bunts well. This helps team “A” stay out of the double play, while possibly moving runners A₁ and A₅ to 2nd and 3rd bases respectively. As illustrated in FIG. 4, player A₂ is circled signifying a replacement runner that may be used later in the game. Player A₆ is represented with a square/rectangle indicating a traditional substitution that cannot return later in the game.

Now assume that the pinch hitter A₆ bunts both runners successfully to second and third bases respectively. As illustrated by FIG. 5 the situation is now one out from the sacrifice bunt, runners are on 2nd and 3rd, and the score is still tied 1-1 in the last of the 9th inning. The defensive manager realizes that the potential winning run is on the 3rd base and the runner on second is meaningless. First base is open. Because a good hitter (player A₃) is at the plate, he elects to give him a base on balls to set up a potential play at any base.

The offensive manger chooses to utilize a replacement runner A₄ and leave his pinch hitter A₆ at the plate for the final game-determining show-down between the pitcher and batter. Whatever the final result, fans will enjoy the tense athletic confrontation.

Use of the proposed modified base-on-balls rule is highly advantageous for professional baseball, both major and minor leagues. It also has additional advantages for other levels of baseball and softball (collegiate, high school, various youth leagues, down to little league, and including tee ball players) in encouraging full player participation and skill development.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. Thus, for example, while the invention has been described.

I claim:

1. A baseball-type game played on a playing field including first, second, and third bases, home plate, an infield and an outfield, said game being carried out in accordance with traditional rules of baseball game play including rules defining strikes, balls, runs and outs, said traditional rules of game play being modified such that a player at bat who is pitched a predetermined number of balls without first reaching a predetermined number of strikes can choose to either: (i) advance to first base; or (ii) stay at home plate and receive additional pitches while a replacement runner advances to first base.

2. The game of claim 1 wherein said traditional rules of baseball game play comprise the Rules of Baseball promulgated by the American Baseball League, National Baseball League, Major League Baseball, or any other professional baseball league.

3. The game of claim 1 wherein said traditional rules of baseball game play comprise the Rules of Baseball promulgated by the NCAA or NFHS.

4. The game of claim 1 carried out using a regulation-sized baseball.

5. The game of claim 1 carried out using a regulation-sized softball.

6. The game of claim 1 wherein said predetermined number of balls is four (4) and said predetermined number of strikes is three (3).

7. The game of claim 1 wherein said replacement runner is selected from the bench or inactive roster.

8. The game of claim 1 wherein said replacement runner is selected from the active roster.

9. The game of claim 1 further comprising the additional rule that a replacement runner may act as a replacement runner only once per inning.

10. The game of claim 1 further comprising the additional rule that a replacement runner may act as a replacement runner only once per game or until the entire roster of other eligible players is exhausted.

11. A method for organizing and carrying out a game of baseball on a baseball field comprising first, second and third bases, home plate, and infield and an outfield, said method comprising:
organizing and carrying out the game in accordance with traditional baseball rules, including rules defining strikes, balls, and strike-outs; and
enforcing a modified base-on-balls rule providing that a player at bat who receives a base-on-balls is given the choice to either take the base or remain at bat for additional pitches while a replacement runner takes the base.

12. The method of claim 11 wherein said traditional baseball rules comprise the Rules of Baseball as promulgated and enforced by the American Baseball League, National Baseball League, Major League Baseball, or any other professional baseball league.

13. The method of claim 11 wherein said traditional baseball rules comprise the Rules of Baseball as promulgated and enforced by the NCAA or NFHS.

14. The method of claim 11 carried out using a regulation-sized baseball.

15. The method of claim 11 wherein said replacement runner is selected from the player bench or inactive roster.

16. The method of claim 11 wherein said replacement runner is selected from the active roster of eligible players.

17. The method of claim 11 wherein a player is allowed to act as a replacement runner only once per inning.

18. The method of claim 11 wherein a player is allowed to act as a replacement runner only once per game or until the entire roster of other eligible players is exhausted.

19. A method for organizing and carrying out a game of softball on a softball field comprising first, second and third bases, home plate, and infield and an outfield, said method comprising:
organizing and carrying out the game in accordance with traditional softball rules, including rules defining strikes, balls, and strike-outs; and
enforcing a modified base-on-balls rule providing that a player at bat who receives a base-on-balls is given the choice to either take the base or remain at bat for additional pitches while a replacement runner takes the base.

20. The method of claim 19 carried out using a regulation-sized softball.
